(19) United States
(12) Patent Application Publication
(10) Pub. No.: US 2025/0187808 A1
(43) Pub. Date: Jun. 12, 2025

(54) INFLATABLE REUSABLE CONTAINERS

(71) Applicant: Naim Joseph Elias, II, South Barrington, IL (US)

(72) Inventor: Naim Joseph Elias, II, South Barrington, IL (US)

(21) Appl. No.: 18/535,571

(22) Filed: Dec. 11, 2023

(51) Int. Cl. B65D 81/02

(52) U.S. Cl. CPC B65D 81/022; B65D 2255/00; B65D 2581/02

(57) ABSTRACT

A reusable system for shipping objects is disclosed. The system includes a container and an inflatable and/or deflatable bladder. The inflatable and/or deflatable bladder is configured to be inserted and/or removed from a cavity defined by an outer shell and inner lining of the container. The inflatable and/or deflatable bladder is configured to inflate to protect objects inside the container, and also to deflate to move the system to a substantially compact configuration.

### BACKGROUND

Embodiments of the present invention generally relate to a reusable system for shipping objects involving a container and an inflatable bladder to protect objects during transit.

Shipping containers and boxes have become very popular with the rise of online retailers, the usage of which has significantly increased since the COVID-19 pandemic. Such containers are traditionally single use, made of cardboard and/or plastic boxes. To protect objects inside, single use cushioning means are used, such as packing peanuts or bags of air, which are thrown away after use and sent to landfills.

### SUMMARY

Systems and methods are disclosed of a reusable inflatable container system that includes a container with an inner lining and an outer shell to support an inflatable and deflatable bladder, substantially as illustrated by and described in connection with at least one of the figures, as set forth more completely in the claims.

### BRIEF DESCRIPTION OF THE DRAWINGS

The foregoing summary, as well as the following detailed description of certain embodiments of the present invention(s), will be better understood when read in conjunction with the appended drawings. For the purpose of illustrating the invention(s), there is shown in the drawings, certain embodiments. It should be understood, however, that the present invention(s) is not limited to the arrangements and instrumentality shown in the attached drawings

FIG. 1 provides a top down view of an example inflatable and/or deflatable bladder, in accordance with aspects of this disclosure.

FIG. 2 provides a top down view of the reusable inflatable container system with the lid open, in accordance with aspects of this disclosure.

FIG. 3 provides a top down view of the inflatable and deflatable bladder inserted into the container, in accordance with aspects of this disclosure.

FIG. 4 provides a front view of the system, in accordance with aspects of this disclosure.

FIG. 5 provides a cross-section of the system provided in the example of FIG. 4.

FIG. 6 provides a top down cross-section of an alternative embodiment, in accordance with aspects of this disclosure.

The figures are not necessarily to scale. Where appropriate, similar or identical reference numbers are used to refer to similar or identical components.

### DETAILED DESCRIPTION OF PREFERRED EMBODIMENTS

Certain aspects of the presently disclosed technology provide example reusable inflatable container systems. The systems include one or more of a container having an inner lining and an outer shell, such that the outer shell envelops the inner lining. The inner lining and the outer shell create a space there between defining a cavity (e.g., to hold items for shipping). An inflatable and/or deflatable bladder may include one or more inflatable and/or deflatable chambers. In an example, the bladder is connected to one or more fluid fill and/or release ports, such that one or more of the inflatable and/or deflatable chambers can be filled and/or emptied (e.g., of fluid) from the one or more fluid fill and release ports.

In some examples, the disclosed inflatable and/or deflatable bladder is configured to be both insertable and/or removable from the cavity defined by the inner lining and the outer shell. As a result, components of the reusable inflatable container system can be employed to ship a variety of payloads, of different shapes and sizes, while being reused numerous times without compromising the quality and usefulness of the system.

Importantly, there exists a need in the shipping industry for reusable and safe shipping containers. According to the Environmental Protection Agency (EPA), containers and packaging make up about 28.1% of municipal solid waste. Around 6,440 tons of paper and paperboard containers ended up in landfills in 2018 alone. In addition to needless waste, around 11% of goods are damaged when they arrive to distribution centers. Damaged goods require the sender to reimburse the customer and/or send a replacement product. These options have a negative effect on a company's profitability. Thus, there is an ongoing need in the industry for reusable containers that better protect the objects contained therein during transit.

The container system described in the present disclosure provides a novel solution to the above-identified issues by providing a reusable shipping container and a reusable, inflatable and/or deflatable bladder to protect a wide variety of objects, and over multiple trips. The bladder provides cushioning to protect products, while also being deflatable and therefore collapsible, to allow for easy storage. The use of a port to allow for a customizable amount of fluid fill also provides flexibility to accommodate objects of various sizes and/or shapes, without the need to store a large number and wide variety of packaging materials, to add additional bladders to fill some empty spaces, and/or to cut away extra cushioning pieces to fit a particular object in a particular package, as is often the case for conventional packaging systems. Accordingly, the disclosed container system provides advantages over existing solutions, as will be discussed in greater detail with respect to the several figures.

As used herein, the term “envelopes” may be used to describe a component or feature surrounding and/or containing another component or feature.

As used herein, the term “bladder” may be used to describe one or more structures, formed of one or many materials, capable of being inflated with a fluid (e.g., gas, air, liquid, etc.).

As used herein, the term “lay flat” or the word “collapsible” mean to move into a substantially two dimensional configuration.

As used herein, the term “circumferential dimension” may be used to describe a distance around one or more surfaces of the container or components thereof.

As used herein, the terms “first” and “second” may be used to enumerate different components or elements of the same type, and do not necessarily imply any particular order.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

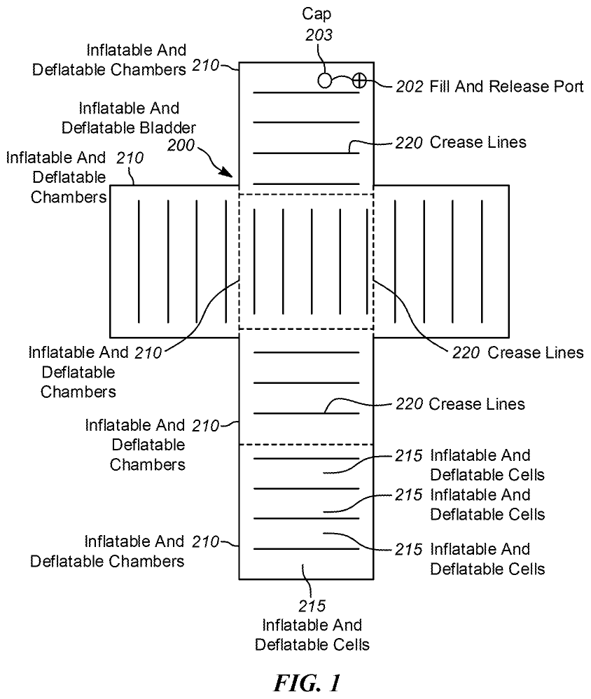

Turning now to the figures, FIG. 1 illustrates an example inflatable and/or deflatable bladder 200 for the disclosed reusable inflatable container system. As shown, the bladder 200 includes one or more inflatable and/or deflatable chambers 210, defined by one or more crease lines 220. For example, the crease lines 220 provide a more uniform distribution of fluid when the bladder is inflated, and assist in folding and/or compression of some joints and/or chambers. Inflatable and deflatable chambers 210 further include inflatable and deflatable cells 215, separated by the crease lines 220. As shown, the cells 215 are fluidly connected from each other at edges of each chamber 210, while separated at internal portions of the chamber by the one or more crease lines 220.

The inflatable and deflatable bladder 200 also includes one or more fill and release ports 202 and one or more caps 203. The inflatable and deflatable cells 215 and inflatable and deflatable chambers 210 are all fluidly connected to allow inflation and deflation of inflatable and deflatable bladder 200 from a single fill and release port. The Inflatable and deflatable bladder of the present embodiment is made of co-extruded polyethylene. The Inflatable and deflatable bladder can be made of any number of flexible materials including rubber or plastic or any material known in the art.

Although a certain number of chambers, crease lines, cells, and/or ports are illustrated in the example of FIG. 1, a greater or lesser number of such features (including zero) may be considered as within the scope of the current disclosure. For instance, a particular container design and/or object may benefit from more or fewer chambers, a greater number of ports (e.g., on two or more chambers-which may or may not be fluidly connected), and/or more of fewer crease lines (including removal of any such lines) to better fill a container (e.g., inner linings and outer shells) and/or support an object.

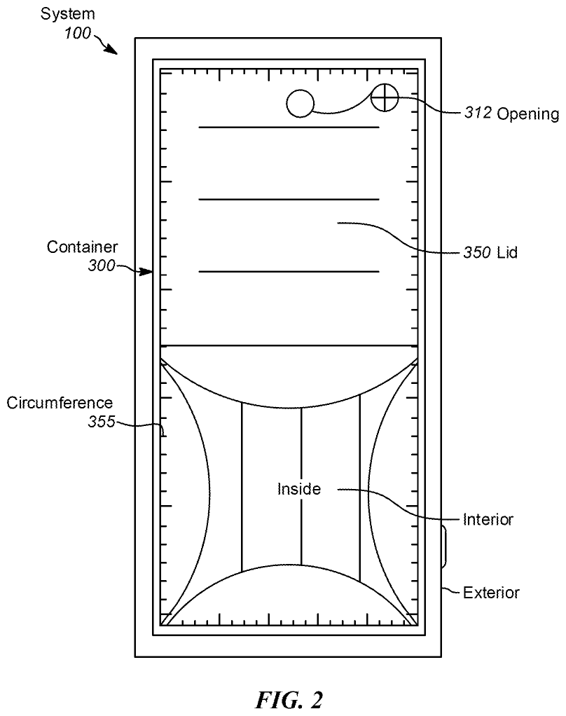

With respect to FIG. 2, an example inflatable container system 100 is inserted within a container 300. As shown in the perspective provided by FIG. 2, the container 300 has an opening 312. In the illustrated example, an opening 312 is located on the inside of lid 350 (shown in an open position) and accommodates one or more fill and release ports 202. FIG. 2 illustrates the system 100 when the bladder 200 is placed inside the container 300 and inflated. Typically, the bladder 200 is more easily inserted into the container 300 deflated, and the port 202 is accessible through the open lid 350. Thus, once situated as desired, fluid can be provided, thereby filling the space between the inner lining 310 and outer shell 330, and cushioning the object within.

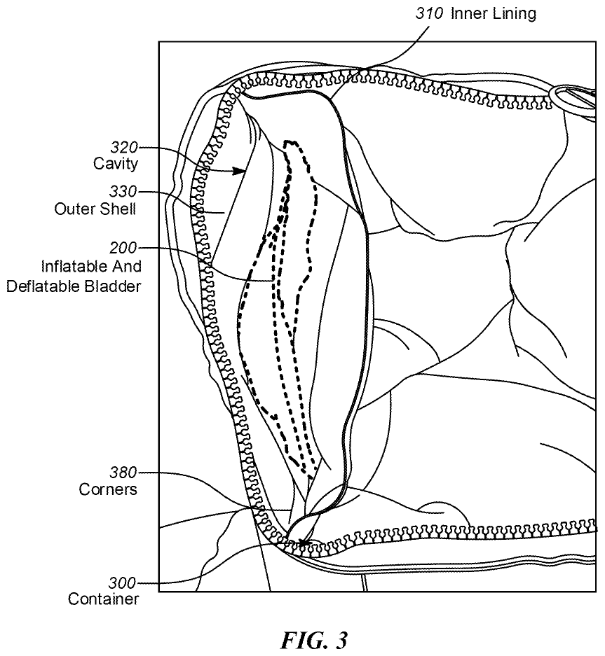

FIG. 3 provides another view of the example container 300 arranged between an inner lining 310 and an outer shell 330. In some examples, the inner lining 310 is attached to the outer shell 330 at corners 380 and at circumference 355. Inner lining 310 and outer shell 330 define a cavity 320 therebetween. The inner lining 310 may be attached to the outer shell 330 with an amount of slack, such that the cavity 320 is defined by a substantially flat outer shell and a rounded inner lining 310. The inflatable and deflatable bladder 200 is inserted into the cavity 320. The inflatable and deflatable chambers 210 extend into the sides 360, the lid 350, and the bottom 370 of the container 300. The cavity 320 may or may not be split into one or more sections, which can be equal to the number of inflatable and deflatable chambers 210.

FIG. 3 illustrates the system 100 when inflatable and deflatable bladder 200 is deflated. The slack provided by the inner lining 310 is configured such that, when inflatable and deflatable bladder 200 is substantially inflated, it tends to inflate in a direction towards the inside of the container (e.g., expanding toward an object therein, as opposed to expanding outer dimensions of the container 300). The inner lining 310 and outer shell 330 are comprised of one or more of a variety of flexible and/or semi-flexible materials known or yet to be developed, including woven, extruded, or otherwise formed fabric, natural fiber, and/or plastic (e.g., polypropylene, nylon, denier-type fabric, etc.), as a list of non-limiting examples. This allows the system 100 to be collapsed into a various configurations (e.g., substantially erect, substantially flat) when inflatable and deflatable bladder 200 is inflated or deflated, while still protecting both the inside and outside from scratches and punctures. In some examples, the inner lining and the outer shell are comprised of a washable material to allow for cleaning. In some examples, the outer shell is comprised of and/or treated with a waterproof material.

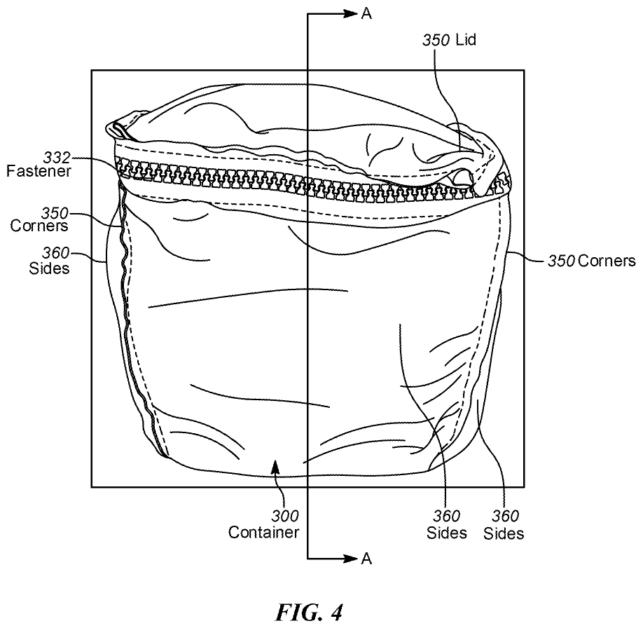

FIG. 4 illustrates the system 100 within container 300 in a closed configuration, with fastener(s) 332 securing the lid 350 to the sides 360. The fastener 332 can be any variety of reusable fastener known or yet to be developed, including a zipper, button, and/or hook and loop, as a list of non-limiting examples. Fastener 332 can also include a lock and/or tamper proof seal to prevent unauthorized access into the container or provide notice thereof.

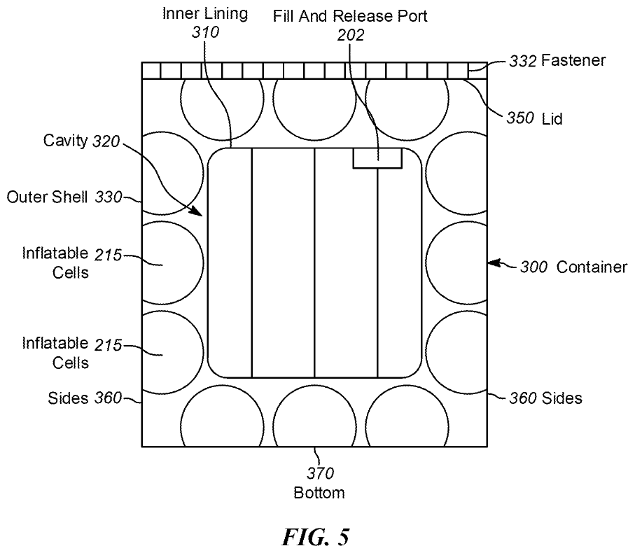

FIG. 5 illustrates a cross-section of system 100 along lines A-A of FIG. 4. As shown, the inflatable and deflatable bladder 200 is inserted between the inner lining 310 and the outer shell 330 and inflated. With inflation, the inflatable and deflatable cells 215 expand within cavity 320 to provide structure to the interior of the inner lining 310 and the exterior of the outer shell 330. This serves to protect objects placed inside the container 300. For example, the inner lining 310 protects the inflatable and deflatable cells 215 from sharp or pointing objects and/or features of the object stored within the container 300. Further, when the inflatable and deflatable bladder 200 is inflated, the outer shell 330 is configured to maintain its circumferential and/or external dimensions, while the inner lining 310 expands toward the inside of the container (e.g., toward the object within). In the example of FIG. 5, the opening 312 reveals the inner lining 310 and the fill and release port 202 accessible when the container is open. Further covers and/or fasteners can be used to limit access to the port 202, to prevent unintentional deflation and/or access to unauthorized individuals.

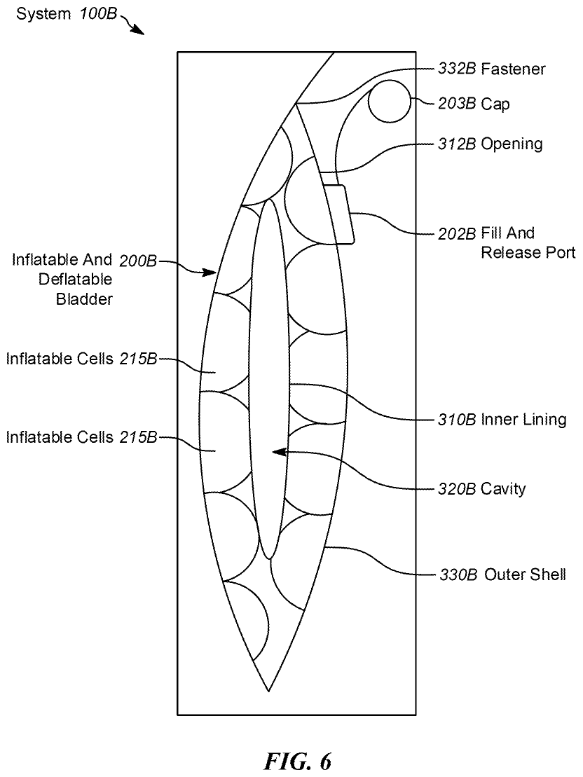

FIG. 6 illustrates an alternative example of an inflatable and deflatable container system 100B. Example system 100B contains an inflatable and deflatable bladder 200B (containing inflatable and deflatable cells 215B) inserted into a container 300B (e.g., container 300 or other container). The container further includes an inner lining 310B, a cavity 320B, and an outer shell 330B. In this example, an opening 312B is placed on the outer shell 330B allowing one or more fill and release ports 202B and one or more caps 203B to be accessible from the outside of the container 300B. In this example, the container 300B is one or more different shapes, such as a cylinder, a sphere, a half-circle, a triangle, a pyramid, a rectangle, and/or one or more variations of these or other geometries. In some examples, the shape is customized for a particular container and/or object, and may have a non-standard shape.

In an example operation, a user can insert inflatable and deflatable bladder 200, 200B into cavity 320, 320B of the container 300, 300B. The user can then place one or more objects to be shipped inside the container 300, 300B. The user then inflates inflatable and deflatable bladder 200, 200B (e.g., via port 202, 202B) to securing and cushion the objects inside. The user can then secure lid 350, 350B to sides 360, 360B via fastener 332, 332B and ship the container to the desired destination. Upon receiving the container, the recipient can open the lid 350, 350B by undoing fastener 332, 332B and retrieve their objects. The recipient can then deflate inflatable and deflatable bladder 200, 200B and collapse system 100, 100B to be substantially flat.

Moreover, inflatable and deflatable bladder 200, 200B can be replaced with a bladder of greater or lesser volume and greater or lesser thickness to accommodate smaller or larger objects placed inside the same container. A greater volume bladder may reduce the volume defined by the inner lining and better prevent movement of smaller objects inside.

In the disclosed examples, the systems can include handles attached to the outer shell to increase the ease of transportation and carrying. The system can also be connectable to other systems to secure multiple packages together for shipping multiple packages to the same location or for storage purposes. The system can also include a shipping label insert to provide an easy means for identifying the origin and destination of the container. Some examples may also include a divider to split the inside of the container into multiple chambers to protect multiple objects. Some examples may also include collapsible inner frame ribs placed between the inner lining and outer shell. The collapsible inner frame ribs add strength and structure to the outer shell when the inflatable and deflatable bladder is inflated, but fold and lay flat when deflated. Some examples may also include an insulating layer placed between the outer shell and inner lining to prevent heat transfer between the inside of the container and the outside environment.

Although some examples are described as containing or employing a single bladder, some examples allow for multiple bladders to be inserted into a container. The bladders may have different shapes and/or volumes, and may support containers have a non-standard shape and/or size, and/or objects having a non-standard shape and/or size. In some examples, two or more bladders may be fluidly connected, such that a single port may be accessed for an assembled container system, while allowing for inflation of each cell of each bladder via a single port.

In another example, the bladders and/or cells are not in fluid communication, thereby allowing for different pressures and/or volumes to be realized in the various bladders and/or cells. In examples, creases can be closed off (e.g., heat-sealed, glued, sonic weld, etc.) from adjacent cells to allow independent inflation of adjacent cells. In such an example, one or more ports may be added to the separated cells to allow for independent inflation. In some examples, one or more cells can be removed and the resulting opening can be resealed, in order to customize the size and/or shape of a bladder.

In disclosed examples, a reusable inflatable container system includes a container including an inner lining and an outer shell, wherein the outer shell envelops the inner lining, the inner lining and the outer shell create a space there between defining a cavity; and an inflatable and deflatable bladder, including one or more inflatable and deflatable chambers; and one or more fluid fill and release ports, wherein the one or more inflatable and deflatable chambers can be filled and emptied from the one or more fluid fill and release ports, wherein the inflatable and deflatable bladder is configured to be both insertable and removable from the cavity defined by the inner lining and the outer shell.

In some examples, the inner lining is comprised of a flexible material and expands inward toward the interior of the container when the inflatable and deflatable bladder is inflated.

In examples, the outer shell maintains its circumferential dimensions upon inflation of the inflatable and deflatable bladder.

In examples, the container is collapsible when the inflatable and deflatable bladder is deflated.

In examples, the system includes collapsible inner frame ribs between the inner lining and outer shell which add structure when the inflatable and deflatable bladder is inflated and lay flat when the bladder is deflated.

In some examples, the one or more chambers includes one or more inflatable and deflatable cells, each of the one or more inflatable and deflatable cell in fluid communication with each other, wherein each inflatable cell can be filled and emptied from the one or more fill and release ports.

In some examples, the one or more fluid fill and release ports are located on the interior of the inner lining, such that they are inaccessible from the exterior of the container when closed.

In some examples, the container is opened and closed via a fastener.

In examples, the fastener is lockable or tamperproof.

In some disclosed examples, a reusable inflatable container system includes a container including an inner lining and an outer shell, wherein the outer shell envelops the inner lining, the inner lining and the outer shell create a space there between defining a cavity, wherein the inner lining and outer shell are comprised of a flexible material and configured to collapse when the system is not in use; and a first inflatable and deflatable bladder that includes one or more inflatable and deflatable chambers; and one or more fluid fill and release ports, wherein the one or more inflatable and deflatable chambers can be filled and emptied from the one or more fluid fill and release ports, wherein the first inflatable and deflatable bladder is configured to be both insertable and removable from the cavity defined by the inner lining and the outer shell, wherein the inner lining expands towards an interior of the container when the first inflatable and deflatable bladder is inflated and the outer shell maintains its circumferential dimensions.

In some examples the system includes a collapsible inner frame ribs between the inner lining and outer shell, the inner frame ribs configured to add structure when the first inflatable and deflatable bladder is inflated, and lay flat when the bladder is deflated.

In examples, the one or more chambers includes one or more inflatable and deflatable cells, each inflatable cell being in fluid communication with each other, wherein each inflatable cell can be filled and emptied from the one or more fill and release ports.

In examples, the one or more fluid fill and release ports are located on the interior of the inner lining such that they are inaccessible from the exterior of the container when closed.

In examples, the cavity is split into a number of sections equal to the number of inflatable and deflatable chambers.

In examples, the container is opened and closed via a fastener.

In examples, the system includes a second inflatable and deflatable bladder configured to be both insertable and removable from the cavity defined by the inner lining and the outer shell.

In some examples, the second inflatable and deflatable bladder has a different volume than the first inflatable and deflatable bladder to protect differently sized items inside of the container.

In examples, the system includes a divider that intersects the interior of the container to protect multiple items within the container.

In examples, the inner lining is comprised of a flexible material and expands inward toward the interior of the container when the first inflatable and deflatable bladder is inflated.

In some disclosed examples, a reusable inflatable container system includes a container including an inner lining and an outer shell, wherein the outer shell envelops the inner lining, the inner lining and the outer shell create a space there between defining a cavity, wherein the inner lining and outer shell are comprised of a flexible material and configured to collapse when the system is not in use; and a first inflatable and deflatable bladder includes one or more inflatable and deflatable chambers; one or more fluid fill and release ports, wherein the one or more inflatable and deflatable chambers can be filled and emptied from the one or more fluid fill and release ports, wherein the one or more fluid fill and release ports are located on the interior of the inner lining such that they are inaccessible from the exterior of the container when closed, wherein the first inflatable and deflatable bladder is configured to be both insertable and removable from the cavity defined by the inner lining and the outer shell, and wherein the inner lining expands towards the interior of the container when the inflatable and deflatable bladder is inflated and the outer shell maintains its circumferential dimensions.

It is to be understood that the invention is not limited in its application to the details of construction and the arrangement of the components set forth in the description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

While various spatial and directional terms, such as top, bottom, lower, mid, lateral, horizontal, vertical, front and the like may be used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

As utilized herein, “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention.

1. A reusable inflatable container system, comprising:
a container including an inner lining and an outer shell, wherein the outer shell envelops the inner lining, the inner lining and the outer shell create a space there between defining a cavity; and
an inflatable and deflatable bladder, comprising:
one or more inflatable and deflatable chambers; and
one or more fluid fill and release ports, wherein the one or more inflatable and deflatable chambers can be filled and emptied from the one or more fluid fill and release ports,
wherein the inflatable and deflatable bladder is configured to be both insertable and removable from the cavity defined by the inner lining and the outer shell.

2. The system of claim 1, wherein the inner lining is comprised of a flexible material and expands inward toward the interior of the container when the inflatable and deflatable bladder is inflated.

3. The system of claim 2, wherein the outer shell maintains its circumferential dimensions upon inflation of the inflatable and deflatable bladder.

4. The system of claim 3, wherein the container is collapsible when the inflatable and deflatable bladder is deflated.

5. The system of claim 4, further comprising collapsible inner frame ribs between the inner lining and outer shell which add structure when the inflatable and deflatable bladder is inflated and lay flat when the bladder is deflated.

6. The system of claim 1, wherein the one or more chambers includes one or more inflatable and deflatable cells,
each of the one or more inflatable and deflatable cell in fluid communication with each other,
wherein each inflatable cell can be filled and emptied from the one or more fill and release ports.

7. The system of claim 1, wherein the one or more fluid fill and release ports are located on the interior of the inner lining, such that they are inaccessible from the exterior of the container when closed.

8. The system of claim 1, wherein the container is opened and closed via a fastener.

9. The system of claim 8, wherein the fastener is lockable or tamperproof.

10. A reusable inflatable container system, comprising:
a container including an inner lining and an outer shell, wherein the outer shell envelops the inner lining, the inner lining and the outer shell create a space there between defining a cavity, wherein the inner lining and outer shell are comprised of a flexible material and configured to collapse when the system is not in use; and
a first inflatable and deflatable bladder, comprising:
one or more inflatable and deflatable chambers; and
one or more fluid fill and release ports, wherein the one or more inflatable and deflatable chambers can be filled and emptied from the one or more fluid fill and release ports,
wherein the first inflatable and deflatable bladder is configured to be both insertable and removable from the cavity defined by the inner lining and the outer shell,
wherein the inner lining expands towards an interior of the container when the first inflatable and deflatable bladder is inflated and the outer shell maintains its circumferential dimensions.

11. The system of claim 10, further comprising collapsible inner frame ribs between the inner lining and outer shell, the inner frame ribs configured to add structure when the first inflatable and deflatable bladder is inflated, and lay flat when the bladder is deflated.

12. The system of claim 10, wherein the one or more chambers includes one or more inflatable and deflatable cells,
each inflatable cell being in fluid communication with each other,
wherein each inflatable cell can be filled and emptied from the one or more fill and release ports.

13. The system of claim 10, wherein the one or more fluid fill and release ports are located on the interior of the inner lining such that they are inaccessible from the exterior of the container when closed.

14. The system of claim 10, wherein the cavity is split into a number of sections equal to the number of inflatable and deflatable chambers.

15. The system of claim 10, wherein the container is opened and closed via a fastener.

16. The system of claim 10, further comprising a second inflatable and deflatable bladder configured to be both insertable and removable from the cavity defined by the inner lining and the outer shell.

17. The system of claim 16, wherein the second inflatable and deflatable bladder has a different volume than the first inflatable and deflatable bladder to protect differently sized items inside of the container.

18. The system of claim 10, further comprising a divider that intersects the interior of the container to protect multiple items within the container.

19. The system of claim 10, wherein the inner lining is comprised of a flexible material and expands inward toward the interior of the container when the first inflatable and deflatable bladder is inflated.

20. A reusable inflatable container system, comprising:
a container including an inner lining and an outer shell, wherein the outer shell envelops the inner lining, the inner lining and the outer shell create a space there between defining a cavity,
wherein the inner lining and outer shell are comprised of a flexible material and configured to collapse when the system is not in use; and
a first inflatable and deflatable bladder, comprising:
one or more inflatable and deflatable chambers;
one or more fluid fill and release ports, wherein the one or more inflatable and deflatable chambers can be filled and emptied from the one or more fluid fill and release ports,
wherein the one or more fluid fill and release ports are located on the interior of the inner lining such that they are inaccessible from the exterior of the container when closed,
wherein the first inflatable and deflatable bladder is configured to be both insertable and removable from the cavity defined by the inner lining and the outer shell, and
wherein the inner lining expands towards the interior of the container when the inflatable and deflatable bladder is inflated and the outer shell maintains its circumferential dimensions.
